(19) United States
(12) Patent Application Publication
(10) Pub. No.: US 2003/0217305 A1
(43) Pub. Date: Nov. 20, 2003

(54) System, method, and computer program product within a data processing system for assigning an unused, unassigned storage device as a replacement device

(76) Inventors: Stanley E. Krehbiel JR., Wichita, KS (US); Carey Wayne Lewis, Wichita, KS (US); William A. Hetrick, Wichita, KS (US); Joseph Grant Moore, Wichita, KS (US)

Correspondence Address: LSI Logic Corporation, Corporate Legal Department, Intellectual Property Services Group, 1551 McCarthy Boulevard, M/S D-106, Milpitas, CA, 95035, US

(21) Appl. No.: 10/145,307

(22) Filed: May 14, 2002

(51) Int. Cl. G06F 11/00

(52) U.S. Cl. 714/6

(57) ABSTRACT

A system, method, and computer program product in a data processing system are disclosed for increasing data storage performance. The data processing system includes multiple primary storage devices and at least one unused, unassigned storage device. A logical volume definition is established that defines a logical volume utilizing the primary storage devices. A failure of one of the primary storage devices is detected. An unassigned storage device is then selected to be used as a replacement drive for the failed device. The selected unassigned storage device is then automatically assigned within the logical volume definition to be a new primary drive as part of the drive group defined by the logical volume definition.

### BACKGROUND OF THE INVENTION

1. Technical Field

The present invention relates generally to data processing systems including storage devices, and more particularly to a data processing system, method, and computer program product for utilizing unused, unassigned storage devices as replacement storage devices.

2. Description of the Related Art

Host computer systems often connect to one or more storage controllers that provide access to an array of storage devices. In a common storage controller, microprocessors communicate the data between the storage array and the host computer system. The host system addresses a “volume” of stored data through the storage controller using a logical identifier, such as Logical Unit Number (LUN) used in SCSI (Small Computer System Interface) subsystems. The term “volume” is often used as a synonym for all or part of a particular storage disk, but it also describes a virtual disk that spans more than one disk. In the latter case, the virtual disk presents a single, contiguous logical volume to the host system, regardless of the physical location of the data in the array. For example, a single volume can represent logically contiguous data elements striped across multiple disks. A file structure can also be embedded on top of a volume to provide remote access thereto, such as Network File System (NFS) designed by Sun Microsystems, Inc. and the Common Internet File System (CIFS) protocol built into Microsoft WINDOWS products and other popular operating systems.

There are many different types of storage controllers. Some storage controllers provide RAID (Redundant Array of Independent Disks) functionality for a combination of improved fault tolerance and performance. In RAID storage controllers on an SCSI bus, for example, the host system addresses a storage element by providing the single SCSI Target ID of the RAID storage controller and the LUN of the desired logical volume. A LUN is commonly a three-bit identifier used on a SCSI connection to distinguish between up to eight devices (logical units) having the same SCSI Target ID. Currently, SCSI also supports LUNs up to 64-bits. The RAID storage controller corresponding to the provided SCSI Target ID translates the LUN into the physical address of the requested storage element within the attached storage array.

A volume ID is another form of logical identifier. Volume IDs are typically 64-bit or 128-bit globally unique persistent world wide names that correspond directly to LUNs or identifiers for other storage representations. By providing a mapping to LUNs, volume IDs can be remapped if there is a collision between LUNs in a storage system, so as to present a set of unique volume IDs to a host accessing the storage system.

The term “RAID” was introduced in a paper entitled “A Case for Redundant Arrays of Inexpensive Disks (RAID)”, Patterson et al., Proc. ACM SIGMOD, June 1988, in which five disk array architectures were described under the acronym “RAID”. A RAID 1 architecture provides “mirroring” functionality. In other words, the data for each volume of a primary storage unit is duplicated on a secondary (“mirrored”) storage unit, so as to provide access to the data on the secondary storage unit in case the primary storage unit becomes inoperable or is damaged.

A RAID 2 architecture provides error detection and correction (“EDC”) functionality.

For example, in U.S. Pat. No. 4,722,085 to Flora et al., seven EDC bits are added to each 32-bit data word to provide error detection and error correction capabilities. Each bit in the resultant 39-bit word is written to an individual disk drive (requiring at least 39 separate disk drives to store a single 32-bit data word). If one of the individual drives fails, the remaining 38 valid bits can be used to construct each 32-bit data word, thereby achieving fault tolerance.

A RAID 3 architecture provides fault tolerance using parity-based error correction. A separate, redundant storage unit is used to store parity information generated from each data word stored across N data storage units. The N data storage units and the parity unit are referred to as an “N+1 redundancy group” or “drive group”. If one of the data storage units fails, the data on the redundant unit can be used in combination with the remaining data storage units to reconstruct the data on the failed data storage unit.

A RAID 4 architecture provides parity-based error correction similar to a RAID 3 architecture but with improved performance resulting from “disk striping”. In disk striping, a redundancy group is divided into a plurality of equally sized address areas referred to as blocks. Blocks from each storage unit in a redundancy group having the same unit address ranges are referred to as “stripes”. Each stripe has N blocks of data of different storage devices plus one parity block on another, redundant storage device, which contains parity for the N data blocks of the stripe. A RAID 4 architecture, however, suffers from limited write (i.e., the operation of writing to disk) performance because the parity disk is burdened with all of the parity update activity.

A RAID 5 architecture provides the same parity-based error correction as RAID 4, but improves “write” performance by distributing the data and parity across all of the available disk drives. A first stripe is configured in the same manner as it would be in RAID 4. However, for a second stripe, the data blocks and the parity block are distributed differently than for the first stripe. For example, if N+1 equals 5 disks, the parity block for a first stripe may be on disk 5 whereas the parity block for a second stripe may be on disk 4. Likewise, for other stripes, the parity disks are distributed over all disks in the array, rather than in a single dedicated disk. As such, no single storage unit is burdened with all of the parity update activity.

A RAID 6 architecture is similar to RAID 5, with increased fault tolerance provided by independently computed redundancy information in a N+2 redundancy group. A seventh RAID architecture, sometimes referred to as “RAID 0”, provides data striping without redundancy information. Of the various RAID levels specified, RAID levels 0, 1, 3, and 5 are the most commonly employed in commercial settings.

A logical volume definition typically includes a logical volume name or identifier, an identifier that identifies one or more physical drives that make up the logical volume identified by the logical volume name, and a logical unit identifier that is used by a host to communicate with the logical volume. For each logical volume, when the RAID standard is used, an indication of the RAID level for each logical volume is also included. Other information may also be included.

When a volume is first created, the user generally specifies a list of drives on which the volume is to be defined. Since a volume definition includes a list of drives, the act of assigning a drive to a volume adds a reference to a drive to the list of drives in the volume definition. Similarly, removing a drive, i.e. to remove a failed drive from the volume definition, deletes the reference to a drive within the volume definition. When a drive is included in a volume definition, the drive is called an “assigned” drive.

Drives may assigned the role of “spare” drive. A list of all drives that are assigned the role of “spare” is maintained with the storage controller. When a primary disk fails, the data that had been stored on the failed drive may be incorporated on one of the drives that had been assigned the role of “spare” drive. Unused, unassigned drives may not be used as spare drives. Thus, a drive must be assigned as a spare before the spare may be used as a replacement drive. FIG. 5 depicts this process in more detail.

FIG. 5 illustrates a block diagram of a storage subsystem in accordance with the prior art. In the depicted example, storage subsystem 500 is a disk drive system including a controller 502. Controller 502 controls primary disk drives 504, 506, and 508. Drive 510 has been designated as a spare drive that may be used in accordance with a RAID level 1, 2, 3, 4, 5, or 6. Drives 512 and 514 exist within storage subsystem 500 as unused drives and have not been designated as spare drives. If a primary drive, such as drives 504, 506, or 508, fails, spare 510 may be used as a replacement drive. If, however, spare drive 510 is in use and an additional spare drive is needed to be used as a replacement drive, neither drive 512 or 514 may be used because they have not already been assigned as spares. In order to use either drive 512 or 514 as a spare, it must first be assigned to be a “spare” within controller 502.

In the example depicted by FIG. 5, disk 508 has failed. According to the prior art, when controller 502 detects that disk 508 has failed, controller 502 selects a designated spare drive, such as spare drive 510, and integrates it by constructing the data that had been stored on disk 508. The data stored on disks 504 and 508 is used to construct the data that had been stored on disk 508 in accordance with the RAID level implemented by the storage subsystem. Once spare 510 is integrated, system 500 may continue to operate with disks 504, 506, and spare 510.

If an additional spare drive is needed, such as for example if primary drive 504 or 506 were to fail, neither unused drive 512 nor 514 could be used because neither drive is designated as a spare drive.

Therefore, a need exists for a system, method, and computer program product for automatically assigning an unassigned, unused drive in a logical volume as a replacement drive.

### SUMMARY OF THE INVENTION

A system, method, and computer program product in a data processing system are disclosed for increasing data storage performance. The data processing system includes multiple primary storage devices and at least one unused, unassigned storage device. A logical volume definition is established that defines a logical volume utilizing the primary storage devices. A failure of one of the primary storage devices is detected. An unassigned storage device is then selected to be used as a replacement drive for the failed device. The selected unassigned storage device is then automatically assigned within the logical volume definition to be a new primary drive as part of the drive group defined by the logical volume definition. The data from the failed drive is then reconstructed onto the replacement drive.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram of a data processing system in accordance with the present invention;

FIG. 2 is a block diagram of a computer system, such as the data processing system of FIG. 1, in which the present invention may be implemented;

FIG. 3A is a block diagram of a storage subsystem, such as one of the storage subsystems of FIG. 1, having a failed drive in accordance with the present invention;

FIG. 3B is a block diagram of a storage subsystem, such as one of the storage subsystems of FIG. 1, having a failed drive where an unused drive has been assigned as a replacement drive in accordance with the present invention;

FIG. 4 depicts a high level flow chart which illustrates utilizing unassigned, unused drives as replacement drives in accordance with the present invention; and

FIG. 5 is a block diagram of a storage subsystem having a failed drive in accordance with the prior art.

### DETAILED DESCRIPTION

The description of the preferred embodiment of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention and the practical application to enable others of ordinary skill in the art to understand the invention for various embodiments with various modifications as are suited to the particular use contemplated.

The present invention is a system, method, and computer program product for dynamically assigning unused, unassigned drives as replacement primary drives. Thus, drives do not need to be designated as spare drives prior to a replacement drive being needed. When a failure of a primary drive is detected, the storage controller identifies unused, unassigned drives. One of these drives is selected by the storage controller to be used as a replacement drive. The storage controller updates the logical volume definition to assign the unused drive as a primary drive and replacement for the failed drive. The data from the failed drive is then reconstructed onto the replacement drive.

With reference now to the figures, and in particular with reference to FIG. 1, a data processing system 100 is depicted according to the present invention. Data processing system 100 includes computer systems 102 and 104, which are connected to storage subsystem 106. In the depicted example, storage subsystem 106 is a disk drive storage subsystem. Computer systems 102 and 104 are connected to storage subsystem 106 by bus 112 and bus 114. According to the present invention, bus 112 and bus 114 may be implemented using a number of different bus architectures, such as a small computer system interface (SCSI) bus or a fibre channel bus.

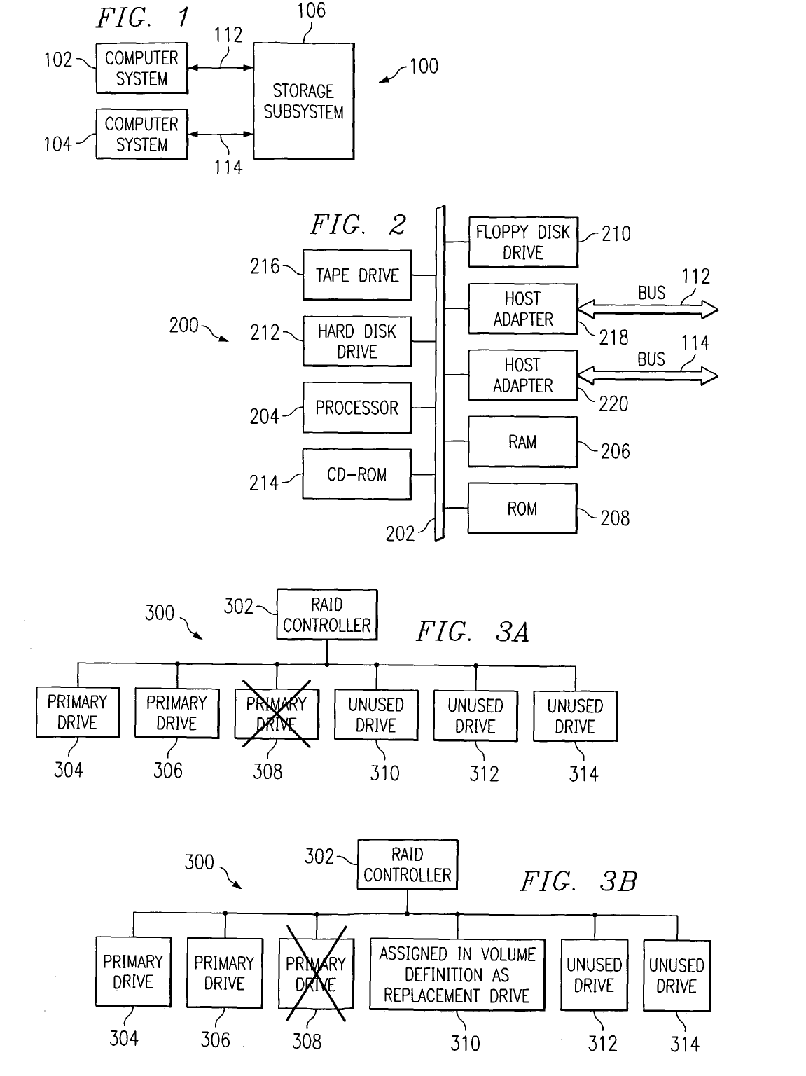

Turning now to FIG. 2, a block diagram of a computer system 200, such as computer system 102 or 104 in FIG. 1, is illustrated in which the present invention may be implemented. Computer system 200 includes a system bus 202 connected to a processor 204 and a memory 206. Computer system 200 also includes a read only memory (ROM) 208, which may store programs and data, such as, for example, a basic input/output system that provides transparent communications between different input/output (I/O) devices. In the depicted example, computer system 200 also includes storage devices, such as floppy disk drive 210, hard disk drive 212, CD-ROM 214, and tape drive 216. Computer system 200 sends and receives data to a storage subsystem, such as storage subsystem 106 in FIG. 1, through host adapters 218 and 220, which are connected to buses 112 and 114, respectively. These host adapters provide an interface to send and receive data to and from a storage subsystem in a data processing system.

A storage subsystem is a collection of storage devices managed separately from the primary processing system, such as a personal computer, a work station, or a network server. A storage subsystem includes a controller that manages the storage devices and provides an interface to the primary processing system to provide access to the storage devices within the storage subsystem. A storage system is typically physically separate from the primary processing system and may be located in a remote location, such as in a separate room. These host adapters provide an interface to send and receive data to and from subsystem in a data processing system.

Programs supporting functions within host computer system 200 are executed by processor,204. While any appropriate processor may be used for processor 204, the Pentium microprocessor, which is sold by Intel Corporation and the Power PC 620, available from International Business Machines Corporation and Motorola, Inc. are examples of suitable processors. “Pentium” is a trademark of the Intel Corporation, and “Power PC” is a trademark of International Business Machines Corporation.

Additionally, databases and programs may be found within a storage device, such as hard disk drive 212. Data used by processor 204 and other instructions executed by processor 204 may be found in RAM 206 and ROM 208.

With reference now to FIGS. 3A and 3B, block diagrams of a storage subsystem, such as storage subsystem 106, are depicted according to the present invention. In the depicted example, storage subsystem 300 is a disk drive (i.e., a hard disk drive) system containing a controller 302. FIGS. 3A and 3B depict additional detail for only one of the controllers and its associated drives of FIG. 2. Controller 302 is connected to bus 112. This controller controls primary disk drives 304, 306, and 308. Disks 310, 312, and 314 are unused, unassigned drives. Disks 310, 312, and 314 have not been designated as spare drives.

In the depicted example, primary disk 308 has failed. According to the present invention, when controller 302 detects that primary disk 308 has failed, controller 302 selects an unused, unassigned drive and assigns, within the volume definition, the selected drive to be a primary drive that is a replacement for the failed drive. Thus, as depicted by FIG. 3B, unused drive 310 was selected by controller 302. Unused drive 310 was dynamically assigned by controller 310 to be a replacement drive. Drive 310 is then no longer unassigned. The data stored on primary disks 304 and 308 is used to construct the data that had been stored on primary disk 308 in accordance with the RAID level implemented by the storage subsystem. This data is then integrated on unused drive 310 that is being used as a replacement drive. Any of the unused drives, such as drives 310, 312, or 314 could have been selected and dynamically assigned as a replacement primary drive. Spare drives do not need to be assigned prior to a replacement drive being needed.

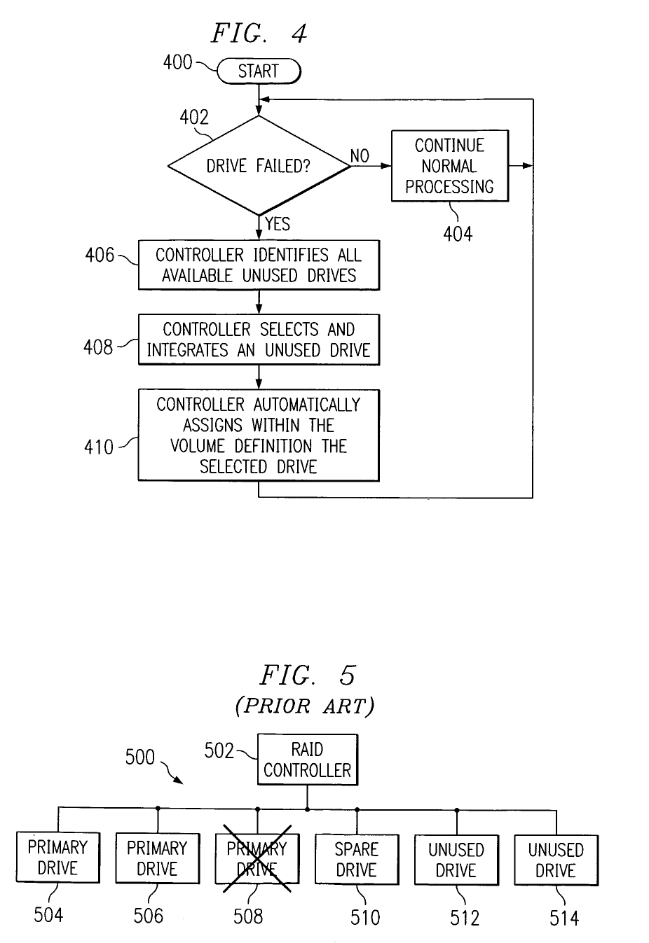

FIG. 4 depicts a high level flow chart which illustrates utilizing unassigned, unused drives as replacement drives in accordance with the present invention. The process starts as depicted by block 400 and thereafter passes to block 402 which illustrates a determination of whether or not a primary drive in the array has failed. If a determination is made that none of the primary drives has failed, the process passes to block 404 which depicts a continuation of normal processing. Referring again to block 402, if a determination is made that a primary drive has failed, the process passes to block 406 which illustrates the storage controller identifying all available unused, unassigned drives. Thereafter, block 408 illustrates the storage controller selecting an unused drive and integrating the selected unused drive. When a drive is integrated, the data that was stored on the failed drive is reconstructed using the remaining drives. The reconstructed data is then stored on the selected drive. The process then passes to block 410 which depicts the storage controller automatically assigning the selected unused drive in the volume definition as a replacement, primary drive. The process then passes back to block 402.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for increasing data storage performance, the data processing system having a plurality of primary storage devices and an unused, unassigned storage device, the method comprising the steps of:
establishing a logical volume definition that defines a logical volume utilizing said plurality of primary storage devices;
detecting a failure of one of said plurality of primary storage devices;
selecting said unassigned storage device to be used as a replacement primary drive; and
automatically assigning, within said logical volume definition, said selected unassigned storage device to be a replacement primary device for said failed one of said plurality of primary storage devices.

2. The method according to claim 1, further comprising the step of reconstructing, on said replacement primary storage device, data that was stored on said failed one of said plurality of primary storage devices at the time said failure was detected.

3. The method according to claim 1, further comprising the steps of:
including within said data processing system a plurality of unassigned storage devices;
selecting one of said plurality of unassigned storage devices to be used as a replacement primary storage device; and
automatically assigning, within said logical volume definition, said one of said plurality of unassigned storage devices to be a replacement primary device for said failed one of said plurality of primary storage devices.

4. The method according to claim 1, further comprising the steps of:
including a storage controller; and
establishing said logical volume definition within said storage controller that defines said logical volume utilizing said plurality of primary storage devices.

5. The method according to claim 1, further comprising the steps of:
including a storage controller; and
detecting, utilizing said storage controller, said failure of said one of said plurality of primary storage devices.

6. The method according to claim 1, further comprising the steps of:
including a storage controller; and
selecting, utilizing said storage controller, said unassigned storage device to be used as said replacement primary drive.

7. The method according to claim 1, further comprising the steps of:
including a storage controller; and
automatically assigning, utilizing said storage controller, within said logical volume definition said selected unassigned storage device to be said replacement primary device for said failed one of said plurality of primary storage devices.

8. The method according to claim 1, further comprising the steps of:
reconstructing, utilizing said storage controller, on said replacement primary storage device data that was stored on said failed one of said plurality of primary storage devices at the time said failure was detected.

9. A data processing system for increasing data storage performance, the data processing system having a plurality of primary storage devices and an unused, unassigned storage device, said system comprising:
a logical volume definition that defines a logical volume utilizing said plurality of primary storage devices;
means for detecting a failure of one of said plurality of primary storage devices;
means for selecting said unassigned storage device to be used as a replacement primary drive; and
means for automatically assigning, within said logical volume definition, said selected unassigned storage device to be a replacement primary device for said failed one of said plurality of primary storage devices.

10. The system according to claim 9, further comprising means for reconstructing, on said replacement primary storage device, data that was stored on said failed one of said plurality of primary storage devices at the time said failure was detected.

11. The system according to claim 9, further comprising:
a plurality of unassigned storage devices;
means for selecting one of said plurality of unassigned storage devices to be used as a replacement primary storage device; and
means for automatically assigning, within said logical volume definition, said one of said plurality of unassigned storage devices to be a replacement primary device for said failed one of said plurality of primary storage devices.

12. The system according to claim 9, further comprising:
a storage controller; and
said storage controller including said logical volume definition.

13. The system according to claim 9, further comprising:
a storage controller; and
said storage controller for detecting said failure of said one of said plurality of primary storage devices.

14. The system according to claim 9, further comprising:
a storage controller; and
said storage controller for selecting said unassigned storage device to be used as said replacement primary drive.

15. The system according to claim 9, further comprising:
a storage controller; and
said storage controller for automatically assigning, within said logical volume definition, said selected unassigned storage device to be said replacement primary device for said failed one of said plurality of primary storage devices.

16. The system according to claim 9, further comprising:
said storage controller for reconstructing, on said replacement primary storage device, data that was stored on said failed one of said plurality of primary storage devices at the time said failure was detected.

17. A computer program product in a data processing system for increasing data storage performance, the data processing system having a plurality of primary storage devices and an unused, unassigned storage device, said computer program product comprising:
instruction means for establishing a logical volume definition that defines a logical volume utilizing said plurality of primary storage devices;
instruction means for detecting a failure of one of said plurality of primary storage devices;
instruction means for selecting said unassigned storage device to be used as a replacement primary drive; and
instruction means for automatically assigning, within said logical volume definition, said selected unassigned storage device to be a replacement primary device for said failed one of said plurality of primary storage devices.

18. The product according to claim 17, further comprising instruction means for reconstructing, on said replacement primary storage device, data that was stored on said failed one of said plurality of primary storage devices at the time said failure was detected.

19. The product according to claim 17, further comprising:
instruction means for establishing a plurality of unassigned storage devices;
instruction means for selecting one of said plurality of unassigned storage devices to be used as a replacement primary storage device; and
instruction means for automatically assigning, within said logical volume definition, said one of said plurality of unassigned storage devices to be a replacement primary device for said failed one of said plurality of primary storage devices.
